(19) United States
(12) Patent Application Publication
(10) Pub. No.: US 2006/0136997 A1
(43) Pub. Date: Jun. 22, 2006

(54) Authentication system and method

(75) Inventors: Michael J. Telek, Pittsford, NY (US); Kurt M. Sanger, Rochester, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 11/022,108

(22) Filed: Dec. 21, 2004

(51) Int. Cl. H04L 9/32

(52) U.S. Cl. 726/5

(57) ABSTRACT

Authentication systems and methods are provided. In accordance with one method, a user identification is determined based upon a signal modulated by a wireless transponder circuit in an identification token. The signal strength of signals modulated by the wireless transponder is monitored over a period of time and a pattern of movement of the identification token is determined. An authentication signal is generated when the sensed pattern of movement of corresponds to a previously stored set of token authentication movements associated with the determined user identification.

### CROSS-REFERENCE TO RELATED APPLICATIONS

This application is related to U.S. Ser. No. ______ (Attorney Docket No. 89269 entitled IDENTIFICATION DISPLAY DEVICE in the name of Telek et al. filed concurrently herewith.

Reference is made to commonly assigned, co-pending patent application U.S. Ser. No. 10/797,683, entitled INTERACTIVE DISPLAY DEVICE filed Mar. 9, 2004 in the name of Cok.

### FIELD OF THE INVENTION

The present invention relates to security and authentication systems intended for controlling a barrier.

### BACKGROUND OF THE INVENTION

Access control systems are electronic systems that are used to control barriers that restrict a person from engaging in a restricted act. In some cases, the barrier prevents an unauthorized person from accessing information such as sensitive financial, personal, political or medical information. In other cases, the barrier prevents an unauthorized person from particular forms of access to people, places and/or things.

In a typical access control system, an identification token, such as an identification badge, is used to provide indicia of identity. Such an identification badge typically comprises a card with name, photograph or other information identifying the appropriate bearer of the badge. Increasingly, such identification badges also incorporate radio frequency identification transponders having data stored therein. The radio frequency identification transponders are read by a co-designed transceiver in the access control system that communicates with the transponders by way of radio frequency signals. The use of transponder-equipped badges facilitates the identification process in that identification data can be read by machine using a convenient proximity style reader.

While the use of such identification tokens provides an access control system that is easy to use and is difficult to counterfeit, there still remains a risk that an unauthorized person can obtain the card and attempt to use it to obtain access to engage in a restricted act such as entering a restricted area. It is for this reason that access control systems also typically require a separate authentication step after an identification badge or some other form of identification token has been provided. In some access control systems, this authentication requires that a user provide a password or passcode. Card readers having keypads that can be used to enter such a password or passcode number scan in which a physical feature of the user or the voice of the user is sampled and compared against a recorded sample. Where a match is found, access to the barrier is allowed.

It will be appreciated that in these embodiments, each point of access in the barrier must be equipped with both a card reader for determining an identity and with a separate input system for obtaining authentication data, such as the keypad or biometric scanner described above. This adds significant cost and complexity at each point of access. This also causes such access control points to be obtrusive.

Gesture recognition has been identified as one method for addressing this problem. For example, U.S. Pat. No. 6,421,453 entitled “Apparatus and methods for a user recognition employing behavioral passwords” filed on May 15, 1998 by Kanevsky et al. describes a method for controlling access to an individual one of a computer and a service and the facility which comprises the steps of pre-storing a predefined sequence of intentional gestures performed by the individual during an enrollment session and extracting the predefined sequence of intentional gestures from the individual during a recognition session and comparing the pre-stored sequence of intentional gestures to the extracted sequence of intentional gestures to recognize the individual. However, gesture monitoring systems such as those described in the '453 patent require costly sensing systems such a video monitoring systems and costly video processing systems adapted to determine whether a user has properly executed the sequence of gestures based upon the signals from the video monitoring systems.

What is desired is an access control system that is capable of executing both an identification function and an authorization function without requiring substantive extra keypads, biometric scanners or other extra componentry. What is also desired is an access control system that incorporates gesture and/or behavioral type authentication processes yet has a cost level that is competitive with conventional identification technologies.

### SUMMARY OF THE INVENTION

In a first aspect of the invention, a method for determining user authentication is provided. In accordance with the method, a user identification is determined based upon a signal modulated by a wireless transponder circuit in an identification token. The signal strength of signals modulated by the wireless transponder is monitored over a period of time and a pattern of movement of the identification token is determined. An authentication signal is generated when the sensed pattern of movement corresponds to a previously stored set of token authentication movements associated with the determined user identification.

In another aspect of the invention, an authentication system is provided. The authentication system has an identification token transceiver circuit having a transmitter circuit portion to radiate a first electromagnetic signal adapted to cause a transponder in an identification token to transmit a responsive signal and a receiver circuit portion adapted to receive the responsive signal from the identification token and to extract identification data from the responsive signal. A signal strength determining circuit is adapted to determine an intensity of the responsive signal received at the antenna, to monitor changes in the determined intensity over time and to provide a monitoring signal having data characterizing such changes. A memory has authentication data characterizing at least one sequence of changes in the intensity of the responsive signal over time, each sequence associated with identification data. A control circuit is adapted to compare the monitoring signal data to authentication data associated with the extracted identification data and to generate an authentication signal when the monitoring signal data and the authentication data correspond.

In another aspect of the invention, a reader system is provided having at least one antenna and a radio frequency transceiver adapted to cooperate with the at least one antenna to generate a first radio frequency signal that causes a radio frequency transponder that is within a range of the first radio frequency transceiver to generate a responsive signal, that senses the responsive signal and that determines identification data therefrom. The reader system further has a signal strength monitoring circuit adapted to detect the strength of the responsive signal at the at least one antenna and to generate a signal strength signal. A reader control circuit is adapted to cause the radio frequency transponder to generate a sequence of second radio frequency signals over a period of time each adapted to cause the radio frequency transponder to generate second responsive signals. Wherein the controller receives a signal strength signal for each second responsive signal and generates signal strength data characterizing the received the signal strength signals.

In another aspect of the invention an authentication system is provided. The authentication system has a user identification means for determining the identification of a user based upon a wireless signal modulated by a transponder circuit in an identification token and a signal strength monitoring means for monitoring the signal strength of wireless signals modulated by the wireless transponder and for determining a pattern of movement of the identification token over a period of time. A control means is provided for generating an authentication signal when the sensed pattern of movement of over the period of time corresponds to a previously stored set of token authentication movements associated with the determined user identification.

### BRIEF DESCRIPTION OF THE DRAWINGS

FIG. 1 illustrates an embodiment of an access control system of the invention;

FIG. 2 shows block diagram of a method for operating the access control system of FIG. 1;

FIG. 3 shows one example of one of a series of token movements that can be detected by the access control system of FIG. 1;

FIG. 4 shows another example of one of a series of token movements that can be detected by the access control system of FIG. 1, with an identification token located at a token position that is closer than an initial position of FIG. 3;

FIG. 5 shows another example of one of a series of token movements that can be detected by the access control system of FIG. 1, with an identification token located at a token position that is further than an initial position of FIG. 3;

FIG. 6 illustrates a pattern of signal strength data sensed during a series of identification token movements;

FIG. 7 illustrates an output of one embodiment of a signal strength monitoring circuit when an identification token is moved in a pattern similar to the pattern of movements that yielded the path of FIG. 6;

FIG. 8 illustrates a schematic block diagram of one embodiment of a signal strength monitoring circuit;

FIG. 9 illustrates one embodiment of a reader circuit having a dual antenna sensing system for further accuracy in monitoring identification token movement;

FIG. 10 illustrates a schematic block diagram of signal strength sensing circuit having a dual antenna sensing system;

FIG. 11 shows another embodiment of the invention wherein the reader system has three antennae;

FIG. 12 shows another embodiment of the invention wherein the reader system has four antennae; and

FIG. 13 shows still another embodiment of the invention having six antennae, an optional reader control circuit and an optional feedback system.

### DETAILED DESCRIPTION OF THE INVENTION

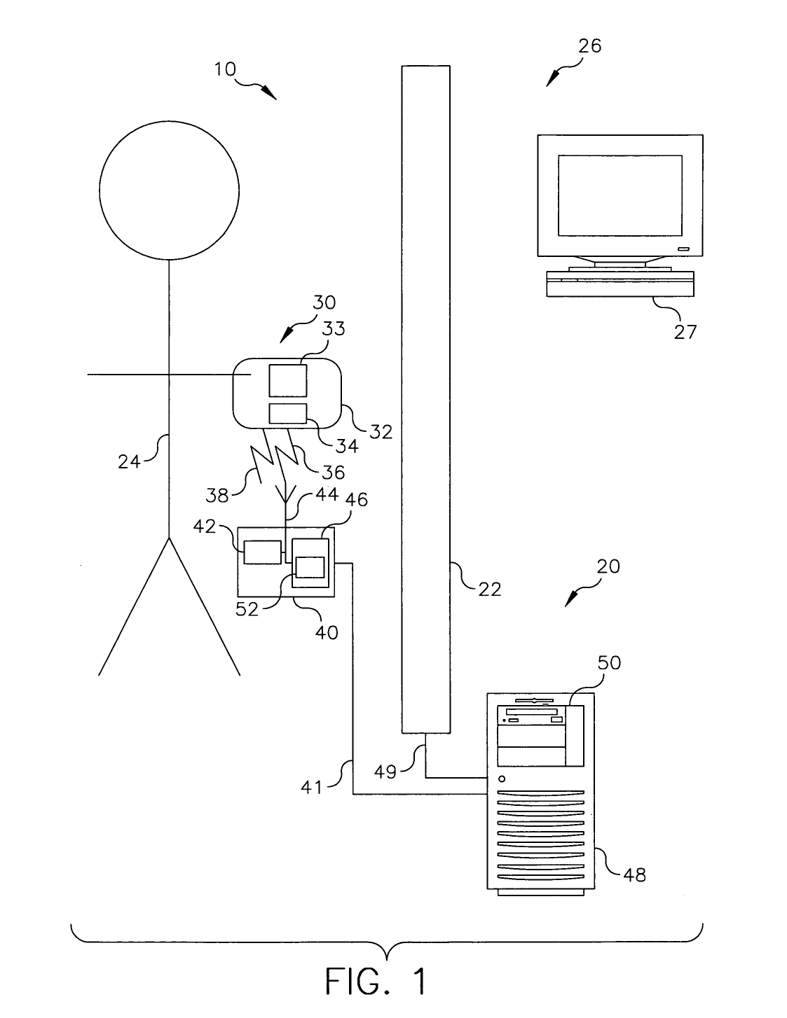

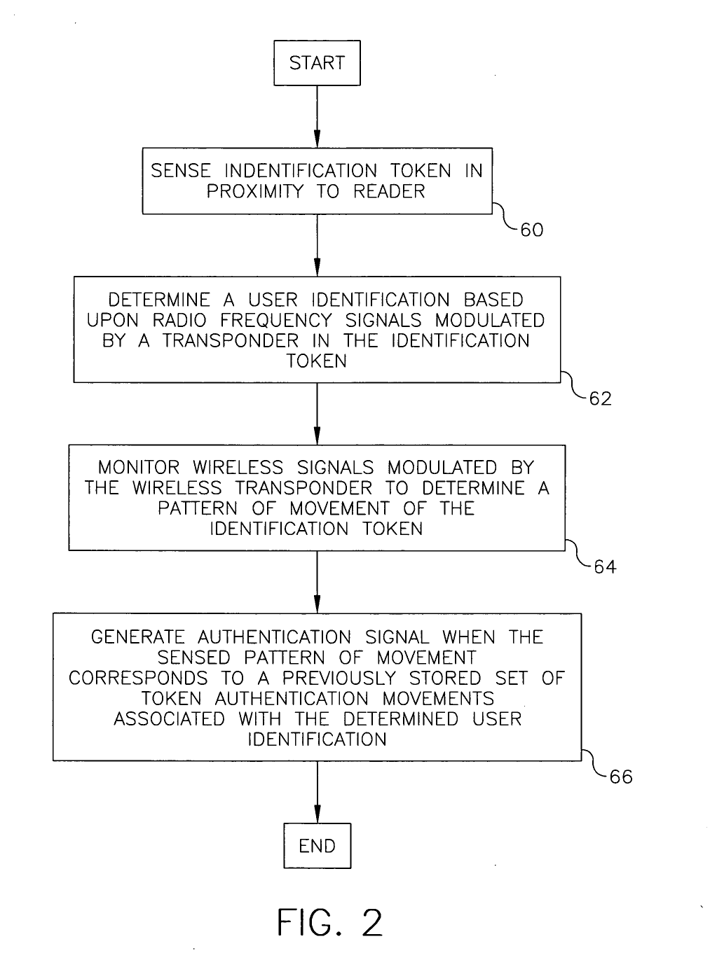

FIG. 1 illustrates an embodiment of an access control system 10 having an authentication system 20. FIG. 2 illustrates a method for determining a user authentication for use with access control system 10 of FIG. 1. As is shown in FIG. 1, access control system 10 has an authentication system 20 that provides authentication signals that are used to control a barrier 22 that restricts a user 24 from engaging in a restricted action. Barrier 22 is adapted so that when barrier 22 receives an authentication signal from authentication system 20 barrier 22 permits user 24 to engage in the restricted action. Authentication system 20 is adapted to provide an authentication signal when user 24 provides both an appropriate form of identification and an appropriate authentication to verify that user 24 is person who is associated with the provided form of identification.

In the embodiment shown in FIG. 1, the provided form of identification is an identification token 30 in the form of an identification badge 32 with an identification image 33 of user 24 and/or other text, graphic, or symbolic identifying information recorded thereon visible or steganographic form. The identification token 30 has a radio frequency transponder circuit 34 therein that is adapted to provide a modulated wireless signal 36. Radio frequency transponder circuit 34 can be of an active type having a power supply that provides power for generating modulated signals. In the embodiment of FIG. 1, transponder circuit 34 is shown as a passive type that extracts operational energy from a polling signal 38 and uses the extracted power to generate modulated signal 36.

A reader system 40 is provided and is adapted to sense the proximity of transponder circuit 34 (step 60) by receiving a modulated signal 36 therefrom. In the embodiment shown in FIG. 1, reader system 40 has transmitter circuit 42 that is adapted to cooperate with an antenna 44 to generate polling signal 38. Polling signal 38 is adapted to cause radio frequency transponder circuit 34 to generate modulated signal 36. Also in this embodiment, reader system 40 has a radio frequency receiver circuit 46 that converts the modulated signal 36 into identification data that is transmitted to a controller 48 of the authentication system 20. In the embodiment shown, the identification data is transmitted to controller 48 by way of a wired communication connection 41 however, a wireless or other type of data connection can be used. Typically, transmitter circuit 42 and receiver circuit 46 are combined in a single transceiver circuit. However, this is not necessary.

Controller 48 has a memory 50 with data stored therein that associates each authorized user with an identifiable modulated signal from a transponder circuit 34. Controller 48 uses this stored association to determine an identity of user 24 (step 62).

Controller 48 then causes receiver circuit 46 to enter into an authentication mode. In the authentication mode, wireless signals 36 modulated by the radio frequency transponder circuit 34 are monitored to determine a pattern of movement of identification token 30. In the embodiment shown, receiver circuit 46 has a signal strength monitoring circuit 52 that is adapted to determine a signal strength of the modulated signal 36 and to generate a monitoring signal that is transmitted using communication connection 41 to controller 48. The monitoring signal has data that reflects a signal strength of the modulated signal during an authentication time period. The signal strength data can comprise a set of data points indicating a sensed signal strength captured over the authentication time period. The signal strength data can also comprise data that reflects a sequence of changes in signal strength over the authentication time period. During the authentication time period, transmitter circuit 42 can transmit a single signal or multiple signals and will monitor signal strength in accordance with the type of signal transmitted.

In this embodiment, transponder circuit 34 and receiver circuit 46 are adapted so that changes in the signal strength of modulated signal 36 are indicative of a change in the relative distance between transponder circuit 34 and antenna 44 of reader system 40. Thus, controller 48 can determine a pattern of movement of identification badge 32 during the authentication time period using the signal strength data.

The detected pattern of movement is used for authentication purposes. Specifically, controller 42 compares the detected pattern of movement with one or more samples of movement patterns stored in memory 50 and associated with the identifiable modulated signal provided by transponder circuit 34. When the sensed pattern of movement of identification badge 32 or other identification token 30 corresponds to a previously stored set of token authentication movements associated with the identification badge 32 or identification token 30, controller 48 generates an authentication signal which can be transmitted to barrier 22 using, for example, barrier communication link 49 (step 66). In the embodiment shown, the authentication signal is transmitted to barrier 22 so that barrier 22 can allow user 24 to perform an action which is restricted by barrier 22.

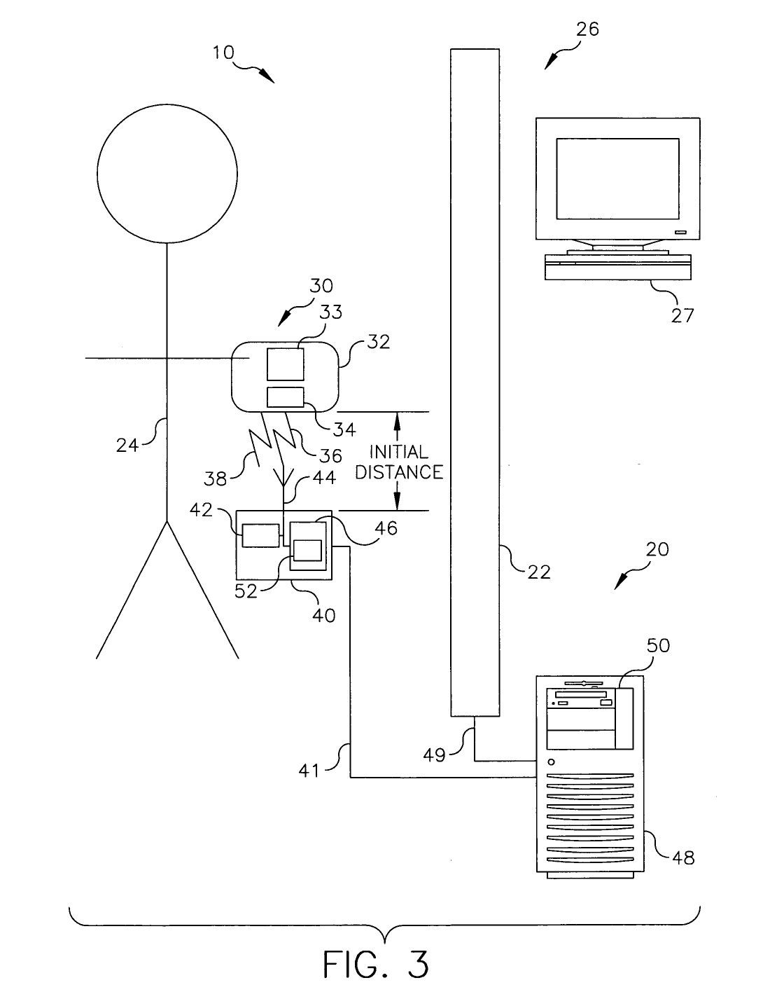

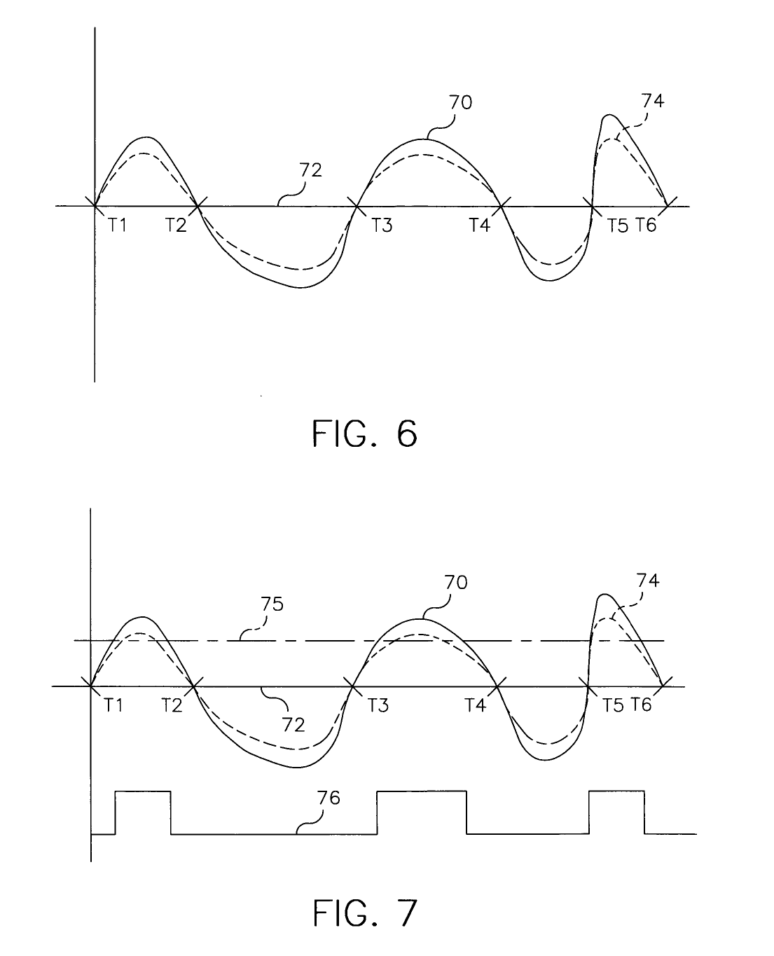

FIGS. 3-6 illustrate one example of a system of this type in operation. FIG. 3 shows a user 24 holding an identification badge 32 at an initial distance from antenna 44 during one portion of authentication process. While identification badge 32 is positioned at the initial distance, signal strength monitoring circuit 52 determines an initial signal strength. This occurs at time T1 in FIG. 6, which illustrates a pattern 70 of the measured signal strength of the modulated signal 36 over an authentication time period which is illustrated therein as the time period between T1 and T6 as compared to a baseline 72 that is determined based upon the initial signal strength.

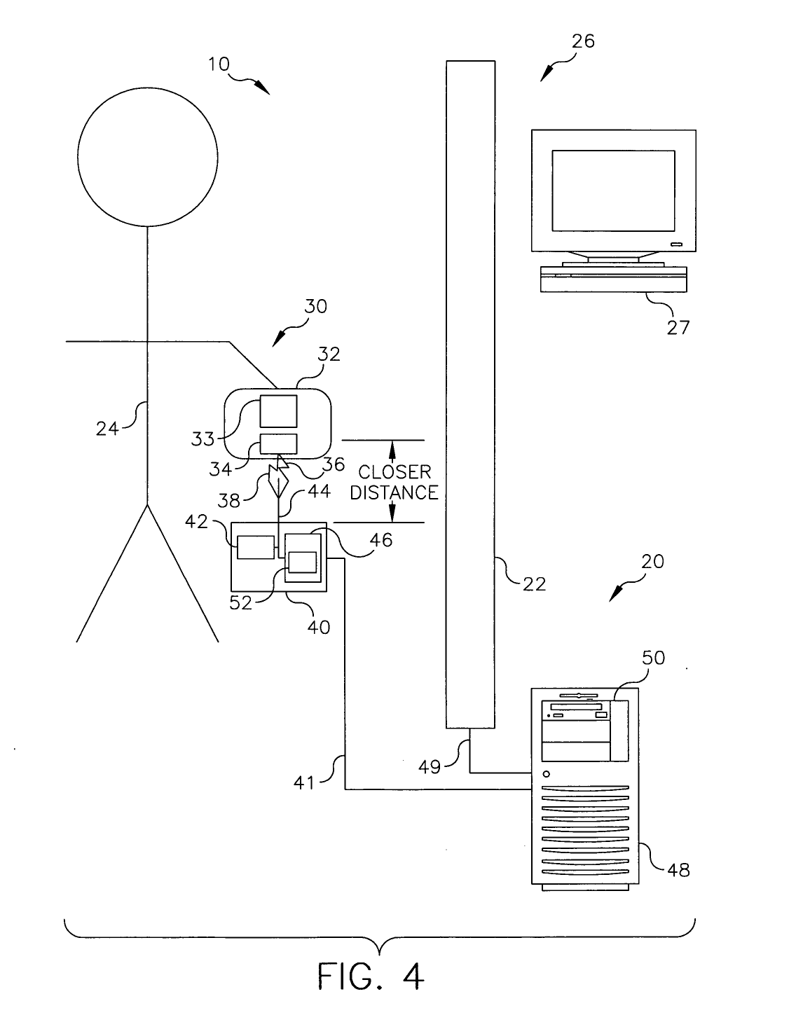

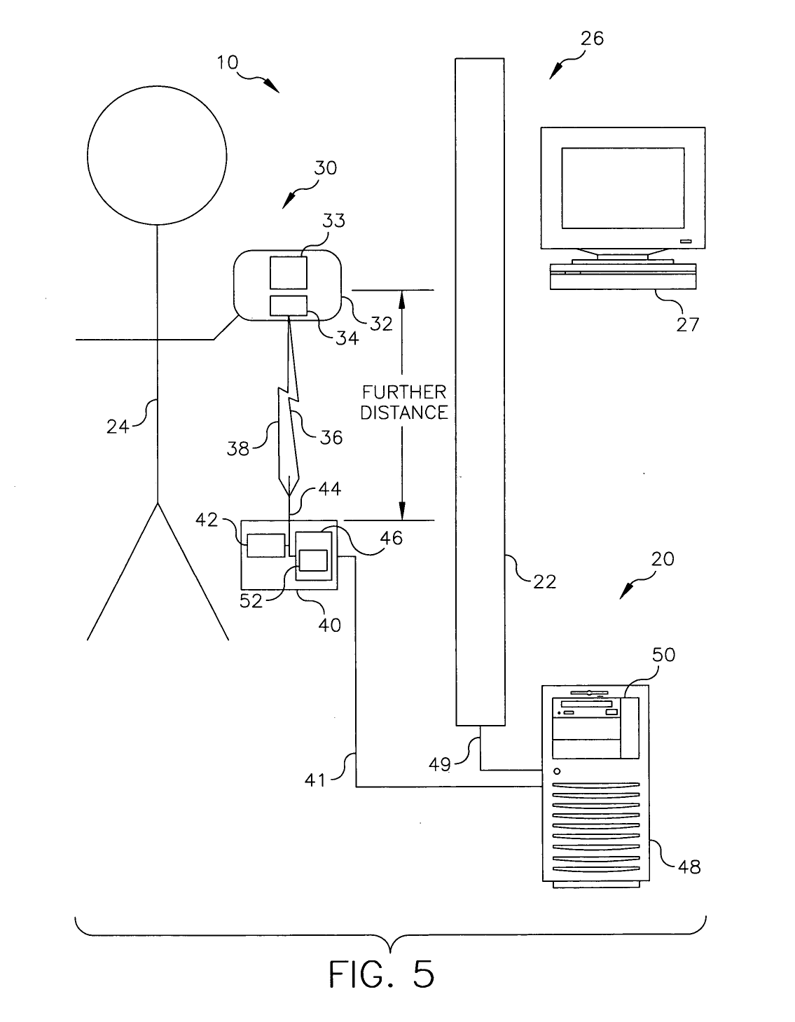

As shown in FIGS. 4 and 6, at times T1-T2, T3-T4 and T5-T6, user 24 has positioned identification token 30 at positions that are closer to antenna 44 used by receiving circuit 46 than the initial position. Therefore, signal strength monitoring circuit 52 detects a signal strength in excess of the baseline 72. This is because the sensed intensity of broadcast radio frequency signals increases in proportion to the square of the distance from the source to a sensor thus, as transponder circuit 34 is moved closer to receiving circuit 46, the strength of wireless signal 36 that is detected by signal strength monitoring circuit 52 increases. Conversely, as shown in FIGS. 5 and 6, at times T2-T3, and T4-T5 user 24 has positioned identification token 30 at positions that are further from antenna 44 than the initial position. Therefore, for the reasons described above, signal strength monitoring circuit 52 detects a signal strength that is less than that of the baseline 72.

Controller 48 authenticates the identity of user 24 by obtaining at least one comparison pattern 74 of authentication movements that have been obtained from user 24 at a previous time. Controller 48 compares pattern 70 of signal strength data obtained during authentication to a comparison pattern 74 to determine whether the patterns are consistent or inconsistent. A wide variety of waveform matching algorithms are known in the electrical engineering and sound sampling arts that can be applied for this purpose. In one simple example, controller 48 can examine pattern 70 to determine the number of transitions from a far positioning of identification token 30 to a close position and the relative proportion of time between transitions. The number of transitions, proportional separation of the transitions, the proportional separation or other aspects of the overall pattern 70 can then be compared to the number of transitions or the proportional separation of the transitions or other aspects of comparison pattern 74. In another embodiment, a range of acceptable variation about comparison pattern 74 can be defined, and so long as pattern 74 is within this range controller 48 can determine that a match exits.

Where controller 48 determines that a correspondence exists, controller 48 generates an authentication signal. This authentication signal can be transmitted to barrier 22 using a wired type of barrier communication link 49 as shown or using a wireless communication link. The authentication signal causes barrier 22 to permit user 24 to engage in a restricted action. In the embodiment shown in FIGS. 1-6 barrier 22 is illustrated as a physical barrier that physically separates user 24 from a restricted domain 26 having a workstation 27 therein. In this regard, barrier 22 can comprise any known form of personal access control such as an electronically controlled door, turnstile, elevator, gate or other such barrier 22. Alternatively, barrier 22 can comprise an electronic barrier such as a firewall or lockout firmware or software or other mechanism or system that bars user 24 from accessing digital data stored in workstation 27 or that bars user 24 from taking some other action using workstation 27, even where user 24 is provided physical access thereto. For example, barrier 22 can limit the uses to which user 24 can put workstation 27, such as limiting access to specific data stored therein or any data that is accessible thereby.

It will be appreciated that there are a variety of existing identity badge readers that have receivers that can receive signals from a transponder in an identity badge. Such readers are known as proximity readers as they do not require an identity token to be physically inserted into the reader for the reader to read identification data therefrom. Certain existing circuits for proximity readers incorporate circuitry that is adapted to sense a signal strength for purposes other than authentication and that can be adapted for use as at least a part of a signal strength monitoring circuit 52. For example, Texas Instruments, of Austin Tex. sells a Series 2000 Reader System having a radio frequency (RF) receiver with three parts: the RF part, an interface part and a logic part as is described in Texas Instruments Registration and Identification System, TIRIS Technology by Texas Instruments, Power Radio Frequency Module RI-RFM-007A Reference Manual, 20 May 1997.

A selective amplifier in the RF Part of the receiver amplifies the RF signal received from an antenna circuit, then demodulates the signal from the transponder, and generates an analog voltage (RSSI) that provides an indication of the received signal strength. The demodulated signal, carrier signal and analog signal strength voltage are all connected to the receiver interface. The demodulated data signal and the carrier signal are converted to logic signals, and connected to the receiver logic for further processing.

The signal strength indicator voltage is converted into RXSS- which is fed directly to a module connector. The signal from the module connector is used where more than one reader is to be operated in a in a local area to ensure that the systems should be synchronized to each other. An intelligent control unit achieves this synchronization by sampling for the presence or absence of the field strength indicator signal RXSS-. A power pulse in the area will cause RXSS- to be active. If the signal RXSS- is present the control unit ensures that the RF module transmits either simultaneously or sequentially to any other proximity in the area. The RXSS- has a comparator that compares the sensed signals to an internal reference level and provides an output that switches to “low” if the received signal strength exceeds the internal reference level. This internal reference level can be adjusted with the two receiver signal strength control inputs. Thus, the series 2000 reader provides a signal strength indicator at RXSS- that is used for calibration and/or synchronization purposes.

In one embodiment of the invention that makes use of such an integral signal strength monitoring circuit 52, this signal strength indicator signal at RSSI can also be used to sense the strength of signals that are modulated by radio frequency supplied to controller 48. For example, this can be done by setting the aforementioned internal reference level to a level that causes the output to transition from low to high as an identification token 30 having a transponder circuit 34 is moved from a first set of distances proximate to the receiver circuit to a second set of distances further from the receiver circuit and vice versa. The pattern 70 of low and high pulses provided as a user 24 moves identification token 30 between the distances can be converted by controller 48 into signal strength data. Unique patterns useful in authentication can be obtained by a time-based analysis of the transitions. In one example, a user can use time modulations such as Morse code patterns to provide an easily remembered authentication signal.

FIG. 7 illustrates the output of a system that has a signal strength monitoring circuit 52 that can provide an output signal that indicates whether a signal from a transponder circuit 34 is above or below a threshold when such a signal strength monitoring circuit 52 is applied to the pattern of identity token movements giving rise to the pattern of sensed signal strength 70 illustrated in FIG. 6. As is illustrated in FIG. 7, in this embodiment, a threshold signal strength level 75 is used to discriminate between times at which identification token 30 is located proximate to antenna 44 of reader system 40 and times at which the signal strength is below this reference level. The output of such an embodiment of signal strength monitoring circuit 52 is then provided to controller 48 to yield a signal strength monitoring signal such as signal 76. Signal 76 can be converted into signal strength data in digital form and the signal strength data can be transmitted in digital form to controller 48 using, for example, communication link 49. However, it will be appreciated that such a signal strength monitoring signal can be provided in analog form to controller 48 with an analog to digital conversion being performed at the controller 48.

In another embodiment of this type, such an approach can be used with any proximity card reader and coupled control system that are adapted to sense an identity token 30 that is within a limited distance of the proximity card reader. In such an embodiment, the signal strength monitoring signal is detected in the form of a pattern of appearances of the same identification token 30 over an authentication time period. During such a authentication time period, user 24 can simply move identification token 30 into and out of a sensing range of the limited distance.

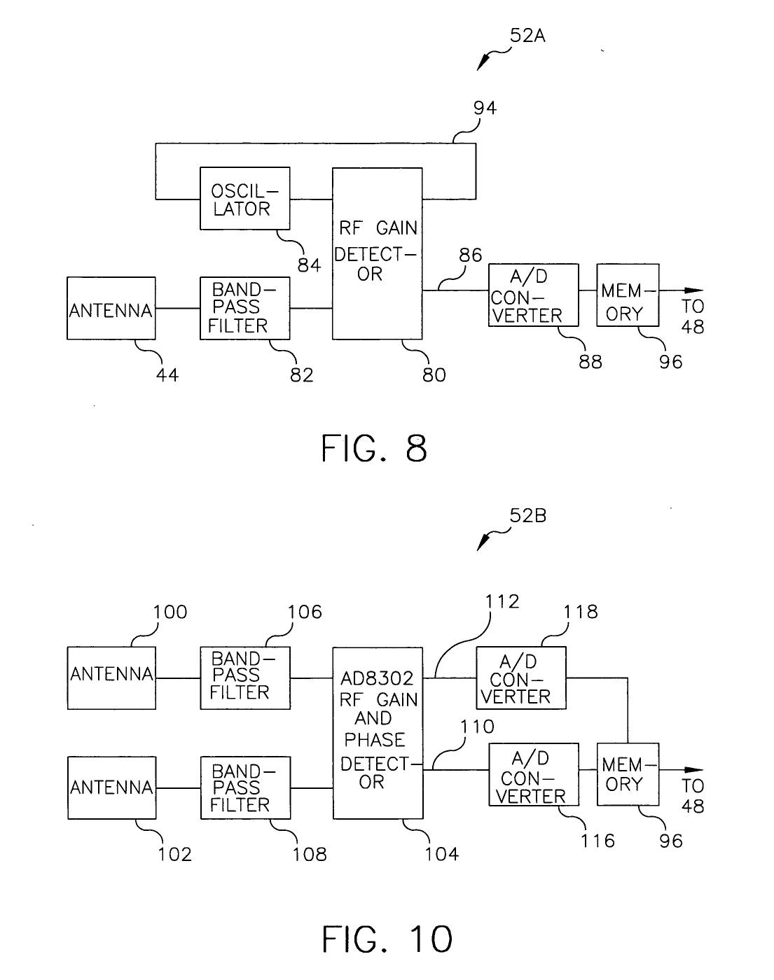

In other embodiments, a signal strength monitoring circuit 52 can be provided in the form of an additional circuit that can be supplied with reading circuit 46 at low cost and that is capable of measuring the amplitude of a returned signal from a transponder circuit 34 of identification token 30. One example of such a circuit is shown in FIG. 8.

As is shown in the embodiment of FIG. 8, an RF gain detector circuit 80, such as AD8302 Gain and Phase Detector sold by Analog Devices of Norwood, Mass., U.S.A., can be used to help provide a signal strength monitoring circuit 52. In the example of FIG. 8, signal strength monitoring circuit 52a is of a single antenna type that uses an antenna 44 that is adapted to receive electromagnetic signals. In this embodiment antenna 44 provides the received signals to a bandpass filter circuit 82 that is adapted to pass received signals in one or more frequencies at which transponder circuit 34 generates modulated signals. The signals that are passed by bandpass filter circuit 82 travel to gain detector 80. An oscillator 84 also provides a signal at such a frequency or frequencies to gain detector 80. Gain detector 80 multiplies the two signals together, and generates an output signal 86 that is the log of the ratio between them. An analog to digital converter 88 converts the output signal 86 from gain detector 80 into a signal strength monitoring signal which can be provided to controller 48. Optionally, a phase signal 94 can be used to adjust the phase of oscillator 84 to coincide with the signal from antenna 44. As a further option, a memory buffer 96 can be provided that is adapted to store amplitude information over a period of time in a digital form so that, during the authentication process, data characterizing the sensed amplitude of the signal modulated by transponder circuit 34 of identification token 30 can be stored locally and provided that the conclusions a verification authentication process to controller 48 without requiring that controller 48 monitors a digital signal representing pattern 70 in real time.

It will be appreciated that, using such an approach, an authentication system 20 of the invention can incorporate a conventional or slightly modified radio frequency identification proximity reader of conventional design and this can be done at low cost and with minimal or no increase in the amount of space occupied by the reader system 40. Thus, the advantages of gesture-based authentication can be made accessible to small businesses, homes and the like.

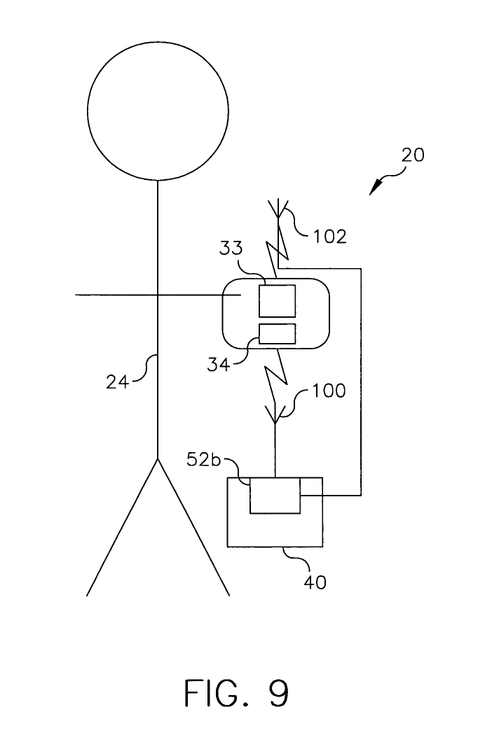

FIG. 9 shows yet another embodiment of the invention. In the embodiment of FIG. 9, reader system 40 is further adapted so that it can cooperate with controller 48 to perform authentication determinations based upon the movement of identification token 30 and transponder circuit 34 as sensed from more than one sensing point. Specifically, in the embodiment of FIG. 9, a reader system 40 is shown having two physically separated antennas, a first antenna 100 and a second antenna 102. By using signals from more than one antenna and a two-antenna signal strength monitoring circuit 52b, a reader system 40 of this embodiment can provide information that more accurately characterizes the movement of identification token 30 so that more complex patterns of authentication movements can be sensed and therefore used to provide greater accuracy and security in the authentication process.

One example of a two-antennae type signal strength monitoring circuit 52b that can be used to detect a pattern of movement using both first antenna 100 and second antenna 102 is shown in FIG. 10. As shown in FIG. 10, a gain and phase detector 104, such as the AD 8302 RF gain and phase detector described above, is used to measure the amplitude and phase of signals received at first antenna 100 relative to the signals received from identification token 30 at second antenna 102. As is shown in FIG. 10, bandpass filter 106 and 108 are provided between antennas 100 and 102 and gain and phase detector 104. Bandpass filter 106 receives signals from first antenna 100 and passes signals having a frequency used in responsive signals generated by a transponder circuit 34 of identification token 30 to gain and phase detector 104. Similarly, bandpass filter 108 receives signals from second antenna 102 and passes the signals having the frequency of signals generated by transponder circuit 34 of identification token 30 to gain and phase detector 104. Gain and phase detector 104 multiplies the two signals together and the output of the log of the ratio between them is provided as signal strength monitoring signal 110.

In the embodiment shown, gain and phase detector 104 is also adapted to detect any phase differential between the signals from bandpass filter 106 and bandpass filter 108, and to provide a phase differential monitoring signal 112 that reflects the variation in phase. The signal strength monitoring signal 110 and phase differential monitoring signal 112 are provided to analog to digital converters 114 and 116 respectively and these signals are provided to controller 48. These signals can be used by controller 48 to determine positional movements, such as movements that bring transponder circuit 34 closer to or further away from antennas 100 and 102.

As a further option, a memory buffer 96 can be provided that is adapted to store data characterizing the signal strength monitoring signal and/or the phase differential over a period of time so that, during the authentication process, data characterizing the phase differential of the signal modulated by transponder circuit 34 of identification token 30 to antennas 100 and 102 can be stored locally and provided to controller 48 at the conclusion of an authentication process without requiring that controller 48 monitor such signals in real time. Using such signals from the two antenna circuit of the embodiment shown in FIG. 10, a pattern of movement of identification token 30 can be monitored with much greater accuracy than in a single antenna embodiment. Thus, as noted above, users can elect to employ a much greater range of authentication movements making such movements more difficult to monitor and accurately emulate. It will be appreciated that the equivalent of the gain and phase detector 104 of the two-antenna signal strength monitoring circuit 52b shown above, can be provided using more than one of the one-antenna embodiment of FIG. 6 to provide data to controller 48, which can, in such an embodiment, be programmed or otherwise adapted to perform one or more of the functions described with reference to gain and phase detector 104 of the two-antennae signal strength monitoring circuit 52b as necessary to provide a desired type of monitoring of the position of identification token 30.

It will further be appreciated that in various embodiments of the invention, a reader system 40 can be provided with combinations of one-antenna signal strength monitoring circuit 52a and/or two-antennae signal strength monitoring circuits 52b to provide greater degrees of sensitivity and more options.

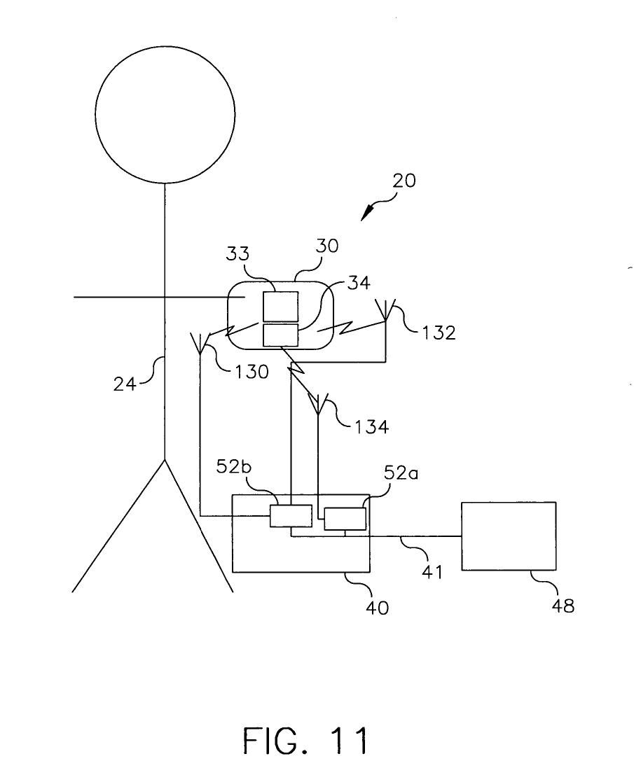

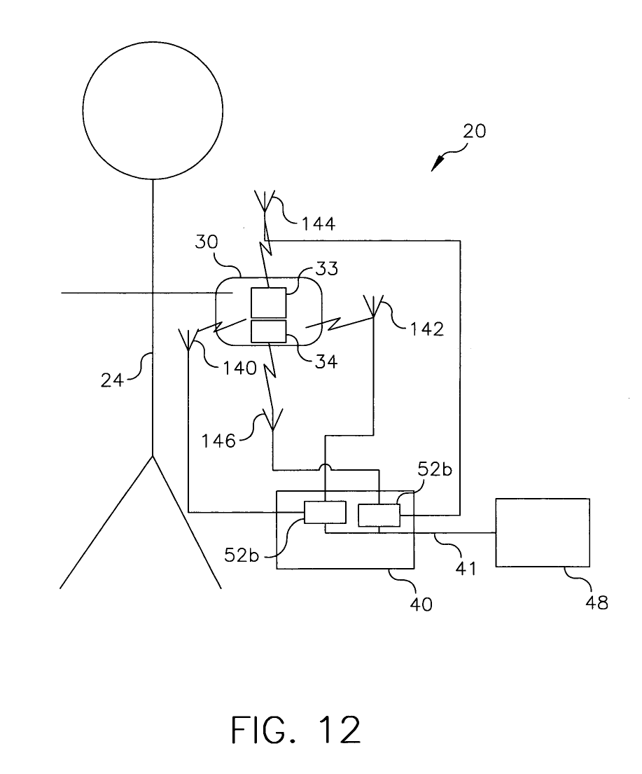

For example, even further improvements in accuracy of monitoring can be made with the addition of a third antenna as is illustrated in FIG. 11. In the embodiment of FIG. 11, a left antenna 130, and a right antenna 132 are provided to sense changes in positional movement of an identification token 30. Left antenna 130 and right antenna 132 are connected using a two antennae embodiment of the signal strength monitoring circuit 52b and provide signal strength monitoring signals to controller 48 that allow controller 48 sense displacement of identification token 30 during the authentication time period. As is further illustrated in FIG. 11, in this embodiment, a third antenna 134 is provided that is associated with a one antenna type embodiment of a signal strength monitoring circuit 52a so that further signal strength monitoring signals can be provided to controller 48 to allow the position of identification token 30 along a closer/farther axis to be monitored by controller 48.

Alternatively, each of antennae 130-134 can be associated with a one-antenna type embodiment of a signal strength monitoring circuit 52a, with each one of the signal strength monitoring circuits 52b providing individual signals to controller 48 so that controller 48 can be determine left/right, closer/farther, and up/down position of identification token 30 using conventional triangulation programming or circuits or other known circuits for determining a position of an item based upon signals received at the three separated points.

FIG. 12 shows another embodiment of the invention wherein reader system 40 has four antennae 140, 142, 144 and 146. In this embodiment, one two-antenna circuit 52b is connected between antennae 140 and 142 for sensing left and right movement of identification token 30, while a second two-antenna circuit 52b is connected between antennae 144 and 146 for detecting closer and further movement of identification token 30.

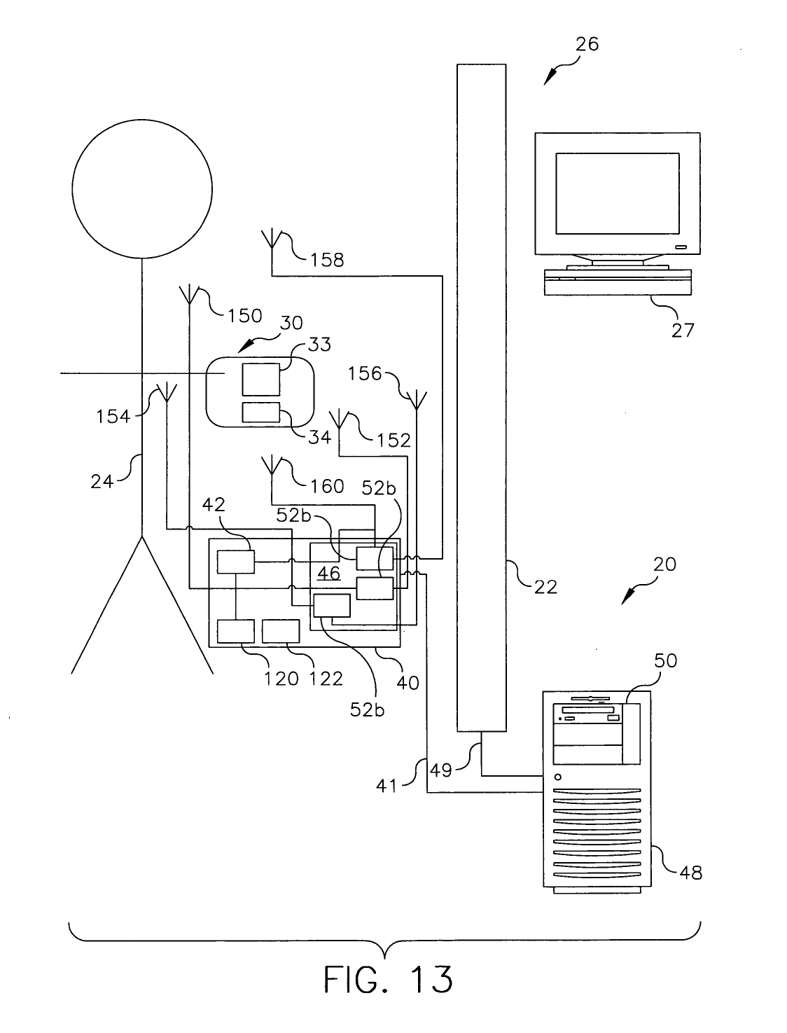

FIG. 13 shows still another embodiment of the invention wherein the reader system 40 has six antennae, two antennae 150 and 152 to measure closer/further movement of identification token 30, 154 and 156 to measure left/right movement of identification token 30 and antennae 158 and 160 to measure up/down movement of identification token 30. In this embodiment, each antenna pair is provided with a two-antennae type of signal strength monitoring circuit 52b. In such an embodiment, controller 48 can analyze the signal strength of signals received at each of the antennae 150-160 to determine a pattern of movement of identification token 30 that is adapted to generate a first radio frequency signal that causes a radio frequency transponder that is within a range of the first radio frequency transponder to respond with a signal, that senses the responsive signal and that determines identification data therefrom. Each signal strength monitoring circuit 52b is adapted to detect the strength of the response at each of antenna pair and to generate a signal strength monitoring signal. Such signal strength monitoring signals can be provided to controller 48 for determination of a pattern of movement of identification token 30 as discussed above or as shown in FIG. 13, a reader control circuit 120 can be provided in reader system 40 that is adapted to cause the radio frequency transmitter 42 to emit at least one first radio frequency signal adapted so that a radio frequency transponder circuit 34 in identification token 30 generates a sequence of second frequency signals over a the authentication time period. Wherein the reader control circuit 120 controller receives the signal strength signals and generates signal strength data characterizing changes in the signal strength signals over the period of time. In the embodiment shown in FIG. 13, reader control circuit communicates this signal strength data to a controller 48 so that controller 48 can make an authentication determination. In another embodiment, reader control circuit 120 can be adapted to make the authentication determination locally and, in such an embodiment, can further be adapted to generate a signal causing barrier 22 to permit user 24 to take a restricted action.

In the embodiment shown in FIG. 13, reader control circuit 120 is optionally adapted to read user identification data, to transmit the user identification data to a remote database (not shown) and receive signals from the remote device having authentication data associated with the user identification so that it is not necessary to store authentication data locally. As is also illustrated in FIG. 13, a feedback system 122 can be provided that is adapted provide a visible, audible or other warning when controller 48 or reader controller 120 detects that a sequence of authentication movements of a identification token 30 does not correspond to a stored comparison pattern 74 for a user associated with identification token 30

Although many of the above described embodiments have been discussed with reference to one antenna signal strength monitoring circuit 52a and two antennae signal strength monitoring circuits 52b, as shown and described in FIGS. 8 and 10 respectively in other embodiments, other conventional types of signal strength monitoring circuits that use one, two or more antennae can be substituted in place of the specific circuits illustrated in FIGS. 8 and 10 above.

The invention has been described in detail with particular reference to certain preferred embodiments thereof, but it will be understood that variations and modifications can be effected within the spirit and scope of the invention.

### PARTS LIST

10 access control system
20 authentication system
22 barrier
24 user
26 restricted domain
27 workstation
30 identification token
32 identification badge
33 identification image
34 transponder circuit
36 modulated signal
38 polling signal
40 reader system
41 communication connection
42 radio frequency transmitter circuit
44 antenna
46 radio frequency receiver circuit
48 controller
49 barrier communication link
50 memory
52, 52a, 52b signal strength monitoring circuit
70 pattern of sensed signal strength
72 baseline
74 comparison pattern
75 threshold signal strength level
76 signal strength monitoring signal
80 RF gain detector circuit
82 bandpass filter circuit
84 oscillator
86 output signal
88 analog to digital converter
94 phase signal
96 memory buffer
100 first antenna
102 second antenna
104 gain and phase detector
106 bandpass filter
108 bandpass filter
110 signal strength monitoring signal
112 phase differential monitoring signal
114 analog to digital converter
116 analog to digital converter
120 reader control circuit
122 feedback system

1. A method for determining a user authentication, the method comprising the steps of:
determining a user identification based upon a wireless signal modulated by a transponder circuit in an identification token;
monitoring the signal strength of wireless signals modulated by the wireless transponder over time;
determining a pattern of movement of the identification token based upon the monitored signal strength; and
generating an authentication signal when the sensed pattern of movement of corresponds to a previously stored set of token authentication movements associated with the determined user identification.

2. The method of claim 1, wherein the wireless modulated signal comprises a radio frequency signal.

3. The method of claim 1, wherein the sensed pattern of movement and the previously stored set of token authentication movements comprise digital data characterizing a pattern changes in signal strength.

4. The method of claim 1 wherein the pattern of movement is determined based upon detected periods of time wherein the sensed signal strength is in excess of a threshold.

5. The method of claim 1, wherein the step of monitoring wireless signals modulated by the transponder to determine a pattern of movement of the identification token comprises monitoring the strength of the wireless signals modulated by the transponder and determining a pattern of changes in the distance from the transponder to a receiver of the wireless signals modulated by the transponder over a period of time based upon changes in the signal strength received by the receiver.

6. The method of claim 1, wherein the step of monitoring wireless signals modulated by the transponder to determine an pattern of movement of the identification token comprises monitoring the strength of the wireless signals modulated by the transponder and determining a pattern of changes in the distance from the transponder to more than one spaced apart receiver of the wireless signals modulated by the transponder over a period of time based upon changes in the signal strength received by the more than one receiver.

7. The method of claim 1, further comprising the step of providing at least one of a visual or audio signal during at least one of the step of detection, the step of monitoring of the movement, and the step of determining indicating that a condition has occurred that will prevent authentication.

8. An authentication system comprising:
an transceiver circuit having a transmitter circuit portion to radiate a first electromagnetic signals adapted to cause a transponder in an identification token to transmit a responsive signals and a receiver circuit portion adapted to receive responsive signals from the identification token and to extract identification data from the responsive signals;
a signal strength determining circuit that is adapted to determine an intensity of the responsive signal received at the antenna, to monitor changes in the determined intensity over time and to provide a monitoring signal having data characterizing such changes;
a memory having authentication data stored therein characterizing at least one sequence of changes in the intensity of the responsive signal over time, each sequence associated with identification data; and
a control circuit adapted compare the monitoring signal data to authentication data associated with the extracted identification data and to generate an authentication signal when the monitoring signal data and the authentication data correspond.

9. The system of claim 8, wherein said memory is further adapted to store the monitoring signal.

10. The system of claim 8, wherein the signal strength determining circuit comprises a memory for storing the monitoring signal.

11. The system of claim 8, wherein the controller is further adapted to generate an authorization signal adapted to be transmitted to a barrier to cause the barrier allow a user to access at least one of restricted information, a restricted area, a restricted person or a restricted thing.

12. The system of claim 11, wherein the barrier comprises a barrier preventing access to electronically encoded information.

13. The system of claim 8, wherein more than one antenna is provided and wherein the signal strength monitoring circuit is adapted to determine signal strength monitoring data for signals received at each antenna.

14. The system of claim 13, wherein each antenna provides a signal to a gain comparator that generates data that characterizes differences in the gain of the signal received at each antenna.

15. The system of claim 13, wherein each antenna provides a signal to a phase comparator that generates phase data that characterizes differences in the phase of the signals received at the antennas.

16. The system of claim 13, wherein the control circuit is adapted to determine a pattern of movement of the identification token during the period of time from the signal strength monitoring data and wherein the authentication data comprises data that characterizes changes in signal strength by characterizing changes in movement of the identification token.

17. The system of claim 13, further comprising a feedback system adapted to generate human perceptible indications when the controller determines that patterns do not correspond.

18. A reader system comprising:
at least one antenna;
a radio frequency transponder adapted to generate a first radio frequency signal that causes a radio frequency transponder that is within a range of the first radio frequency transponder to respond with a signal, said radio frequency transponder having a receiver circuit that senses the responsive signal and that determines identification data therefrom,
a signal strength monitoring circuit adapted to detect the strength of responsive signals received at each of at least one antenna and to generate a signal strength signal; and
a reader control circuit adapted to cause the radio frequency transponder to generate the first radio frequency signal and a sequence of second radio frequency signals over a period of time each second radio frequency signal being adapted to cause the radio frequency transponder to generate second responsive signals;
wherein the controller receives the signal strength signal and generates signal strength data characterizing changes in the signal strength signal of the second responsive signals over the period of time, said signal strength data being usable by a remote device in determining whether an authorization signal is to be generated.

19. The reader system of claim 18, further comprising a memory for storing the signal strength data.

20. The reader system of claim 19, wherein said reader control circuit is further adapted to receive signals from a remote device and to provide stored signals strength data to a remote device.

21. The reader system of claim 19, wherein said reader control circuit is further adapted to control a barrier and that is adapted to receive a signal from the remote device authorizing access to the restricted area and that cause the barrier to permit such access.

22. The reader system of claim 19, further comprising a feedback system adapted to provide an indication in human detectable form when controller detects that a sequence of movements of the identification token does not correspond to stored authentication data for a user associated with that token.

23. An authentication system comprising:
a user identification means for determining the identification of a user based upon a wireless signal modulated by a transponder circuit in an identification token;
a signal strength monitoring means for monitoring the signal strength of wireless signals modulated by the wireless transponder and for determining a pattern of movement of the identification token over a period of time and;
a control means for generating an authentication signal when the sensed pattern of movement of over the period of time corresponds to a previously stored set of token authentication movements associated with the determined user identification.
